(19) United States
(12) Patent Application Publication
(10) Pub. No.: US 2011/0200496 A1
(43) Pub. Date: Aug. 18, 2011

(54) SYSTEM AND METHOD FOR ARRANGING HEATING ELEMENT IN CRYSTAL GROWTH APPARATUS

(75) Inventors: Chandra P. Khattak, Nashua, NH (US); Santhanaraghavan Parthasarathy, Nashua, NH (US); Dean Skelton, Fitzwilliam, NH (US); Ning Duanmu, Nashua, NH (US); Carl Chartier, Manchester, NH (US)

(73) Assignee: GT SOLAR, INCORPORATED, Merrimack, NH (US)

(21) Appl. No.: 12/933,300

(22) PCT Filed: Mar. 19, 2009
(86) PCT No.: PCT/US2009/037605

§ 371 Date: Apr. 13, 2011

Related U.S. Application Data
(60) Provisional application No. 61/037,956, filed on Mar. 19, 2008.

(51) Int. Cl. B01D 9/00; B23P 11/00

(52) U.S. Cl. 422/245.1; 29/428

(57) ABSTRACT

Systems and methods for arranging a heating element in a crystal growth apparatus include connecting elements such as heater clips used to interconnect one or more heating components of the heating element, and to connect at least one of the heating components with the crystal growth apparatus. The heating components can be electrically and thermally coupled, and can be connected via the same circuit, in order to simplify control of the heating element.

### CROSS-REFERENCE TO RELATED APPLICATION

This application claims the benefit of copending application U.S. Provisional Application Ser. No. 61/037,956 filed on Mar. 19, 2008, the disclosure of which is expressly incorporated herein by reference in its entirety.

### FIELD OF INVENTION

The present invention relates to furnaces for crystal growth and directional solidification, and more particularly to a system and method for arranging at least one heating element in a crystal growth apparatus.

### BACKGROUND OF THE INVENTION

Directional solidification systems (DSS) are used for the production of multicrystalline silicon ingots, for example, for use in the photovoltaic industry. A DSS furnace is used for crystal growth and directional solidification of a starting material such as silicon. In DSS processes, silicon feedstock can be melted and directionally solidified in the same furnace. Conventionally, a crucible containing a charge of silicon is placed in a furnace with a heating element arranged near the crucible.

The heating element used in a DSS furnace can be resistive or inductive. In the case of resistance heating, current flows through a resistor and heats up the heating element, and the heating element can be designed with a particular material, resistivity, shape, thickness, and current path to meet operating temperature and power requirements. In induction-type heating, typically a water-cooled heating coil surrounds the silicon charge, and the current flowing through the coil is coupled by the charge to achieve appropriate heating of the charge.

DSS furnaces are particularly useful for crystal growth and directional solidification of silicon ingots used in photovoltaic (PV) applications. Such furnaces also can be used to grow silicon ingots for semiconductor applications. For either type of application, it is desirable to produce large silicon ingots to lower average production costs. However, as larger ingots are produced, it becomes increasingly difficult to control heat flow through the DSS furnace in order to achieve a substantially controlled heating and heat extraction during production of the ingot. If heat flow is not substantially controlled throughout, quality of the product may suffer.

In silicon ingot production by directional solidification, resistance-type heating elements typically are used. The heating element may be cylindrical in shape, so as to surround a crucible containing a silicon charge, where heat is provided to melt the charge. For PV applications, a rectangular/square cross-section ingot is desirable, and the heating element can be cylindrical or rectangular/square. After the charge is melted, heat is extracted from the charge in a controlled manner to promote directional solidification.

In practice, as the cross-sectional area of ingots becomes larger, furnaces are designed with multiple heating elements in an effort to control heat flow. For example, in certain applications, multiple heating elements have been used to control the temperature gradient in different zones. However, the use of multiple heating elements adds to the complexity of the system, and makes it difficult to control heat flow precisely, especially in a production environment.

It would be desirable to provide an arrangement in which a heating element is configured in a furnace so as to precisely control heat flow through the furnace. It would also be desirable to arrange the heating element in a manner to simplify control of the heating element. The crystal growth and directional solidification system and related methods should overcome the deficiencies of the presently available methods and systems.

### SUMMARY OF THE INVENTION

Systems and methods for arranging a heating element in a crystal growth apparatus are provided, where the crystal growth apparatus can be a furnace that promotes crystal growth and directional solidification of a charge, for example, a silicon charge used to form an ingot. A heating element is arranged in the apparatus, where the heating element preferably includes at least first and second heating components that are electrically and thermally coupled, and can be connected via the same circuit. At least one connecting element can be provided to connect at least one of the first and second heating components to the crystal growth apparatus, and the at least one connecting element also is used to interconnect the first and/or second heating components. Further, additional connecting elements may be provided to connect sections of the first and second heating components. The connecting elements can be heating clips used to form mechanical interconnections. The heating clips can be sized appropriately so that the first and/or second heating components of the heating element are spaced at a predetermined distance from a crucible containing the charge in the crystal growth apparatus.

By providing a plurality of heating components, it is possible to vary the power ratio between the components by designing each component with a desired resistance.

A crystal growth apparatus according to the subject invention can include: a feedstock material received in a crucible, the crucible arranged in the apparatus; and a heating element arranged in the apparatus, the heating element including at least a first heating component operably connected to a second heating component, the first and second heating components configured to heat and melt the feedstock material.

Other aspects and embodiments of the invention are discussed below.

### BRIEF DESCRIPTION OF THE DRAWINGS

For a fuller understanding of the nature and desired objects of the present invention, reference is made to the following detailed description taken in conjunction with the accompanying drawing figures wherein like reference character denote corresponding parts throughout the several views and wherein:

FIG. 1 is a cross-sectional front view of a crystal growth apparatus incorporating a heating element according to the subject invention;

FIG. 2 is a perspective view of the heating element shown in FIG. 1;

FIG. 3 is an enlarged perspective view of the heating element of FIG. 2 showing a plurality of heater clips for interconnecting components of the heating element, and attaching the heating element to the crystal growth apparatus;

FIG. 4 is a top plan view of the heating element of FIG. 3;

FIG. 5 depicts various views of a heater clip according to a first preferred embodiment suitable for use with the heating element of FIG. 3; and

FIG. 6 depicts various views of a heater clip according to a second preferred embodiment suitable for use with the heating element of FIG. 3.

### DEFINITIONS

The instant invention is most clearly understood with reference to the following definitions:

As used in the specification and claims, the singular form “a”, “an” and “the” include plural references unless the context clearly dictates otherwise.

A “furnace” or “crystal growth apparatus” as described herein refer to any device or apparatus used to promote crystal growth and/or directional solidification, including but not limited to crystal growth furnaces and directional solidification (DSS) furnaces, where such furnaces may be particularly useful for growing silicon ingots for photovoltaic (PV) and/or semiconductor applications.

### DETAILED DESCRIPTION OF THE INVENTION

A system for arranging a heating element in a crystal growth apparatus, for example, a furnace used to promote crystal growth and/or directional solidification, preferably includes a crucible arranged on a directional solidification block in the furnace, the crucible configured to receive a feedstock material such as silicon. A heating element is arranged in the apparatus, where the heating element includes at least one component, preferably at least a first heating component and a second heating component that are electrically and thermally coupled, and can be connected via the same circuit. By providing a plurality of heating components, it is possible to vary the power ratio between the components by designing each component with a desired resistance.

At least one connecting element can be provided to connect the at least first and second heating components, where the at least one connecting element can be provided to connect the first and/or second heating components to the crystal growth apparatus, and to interconnect the first and second heating components. Further, the connecting elements can be heating clips that are mechanically connected, for example, by fasteners to each other and/or the crystal growth apparatus. The heating clips can be sized appropriately so that the first and/or second heating components of the heating element are spaced at a predetermined distance from the crucible. The system and related methods of arranging the heating element in the crystal growth apparatus are encompassed by the invention.

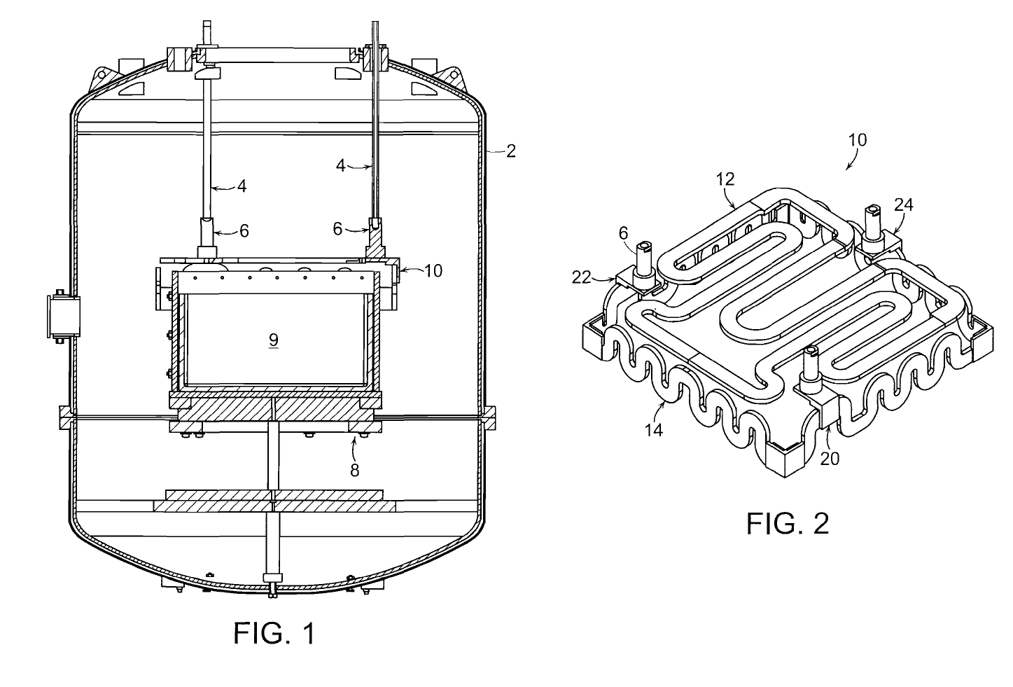

A crystal growth apparatus 2 is depicted in FIG. 1, where the crystal growth apparatus 2 can be a furnace for growing ingots from a feedstock material such as silicon. Preferably, the apparatus 2 is a directional solidification (DSS) furnace which utilizes a directional solidification process to promote crystal growth and directional solidification. A directional solidification block 8 is supported inside the apparatus 2, and configured to receive a crucible 9 containing a charge, for example, a silicon charge.

A heating element 10 preferably is arranged in the crystal growth apparatus 2, where the heating element 10 can be supported by a plurality of support elements 4 attached to electrodes 6 that are connected to the heating element 10. The support elements 4 preferably incorporate electrical wiring for electrically connecting the heating element 10 via a circuit, in order to deliver power to the heating element 10 and control operation of the heating element 10.

Referring to FIG. 2, the heating element 10 preferably includes a plurality of heating components, where the components are operably connected preferably in a single circuit. As shown in FIG. 2, the heating element 10 preferably includes at least a first heating component 12 and a second heating component 14, where the heating components are thermally and electrically connected, such that the heating components function essentially as a single heater. For example, the first heating component 12 can be a top heater, and the second heating component 14 can be a side heater, each of the top and side heaters including a plurality of coils.

It is desirable, particularly in applications for growing large ingots, to provide multiple heating elements and/or components, in order to achieve substantially even heating of the entire feedstock contained in the crucible and adequately control heat flow through the furnace. According to the subject invention, multiple heating components can be connected together, in order to provide integral control of the heating components. Although the heating element is described with reference to first and second heating components, it is within the scope of the invention to provide only a single heating component, or additional heating components, for example, three or more heating components in a heating element. In other words, the heating element 10 preferably includes one or more heating components, and these components preferably are linked together such that the heating element 10 is driven via a single circuit.

According to the subject invention, one or more connecting elements can be used to connect at least one of the first heating component and the second heating component to the crystal growth apparatus, the connecting elements also being used to interconnect the first and second heating components. The one or more connecting elements described herein can be clips for mechanically connecting the various heating components and/or the crystal growth apparatus.

Referring to FIGS. 2-4, a plurality of clips 20, 22, and 24 are provided for connecting at least the second heating component 14 to the crystal growth apparatus 2. In this case, three such clips are shown, although any number of clips can be used. For example, a suitable number of clips for a particular application may be between about 2-15 clips, although a greater or smaller number of clips is encompassed by the invention. In practice, it may be suitable to use about 3-6 clips. Each clip includes a plurality of holes for receiving fasteners such as bolts, screws, or the like. Referring to FIG. 2, the clips 20, 22, and 24 each are configured to receive the electrode 6, which can be attached to the support element 4 for supporting and electrically connecting the heating element 10 in the crystal growth apparatus 2. Although three clips are depicted in FIG. 2, any number of clips can be used, depending on how the heating element 10 is configured to be supported in the apparatus 2. In addition, one or more of the clips can be electrically connected to a circuit for controlling the heating element 10, while other clips may be electrically inactive.

As shown in FIG. 2, the clips 20, 22, and 24 are approximately equally spaced from one another, thereby adequately supporting the heating element 10. Although the clips as shown are connected to the second heating component 14, in use, the clips preferably are attached to both the first and second heating components 12, 14. Alternatively, the clips may be attached to only one of the heating components, and the heating components may be interconnected by other connecting elements. As a further alternative, some of the clips could be used to interconnect both the first and second heating components with the crystal growth apparatus, while other clips may connect only one of the first and second heating components with the crystal growth apparatus.

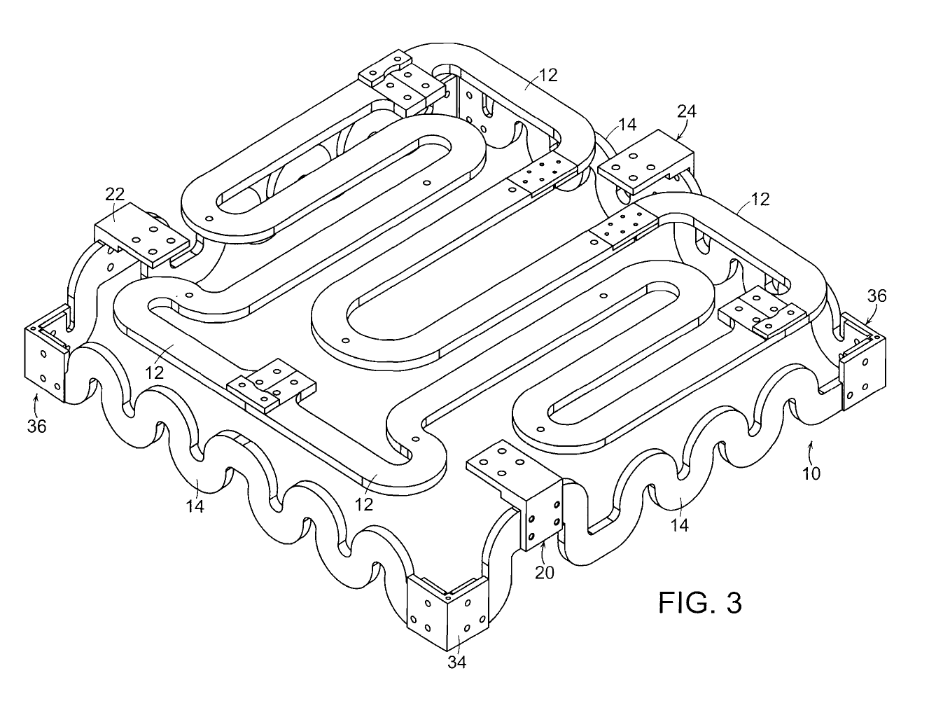

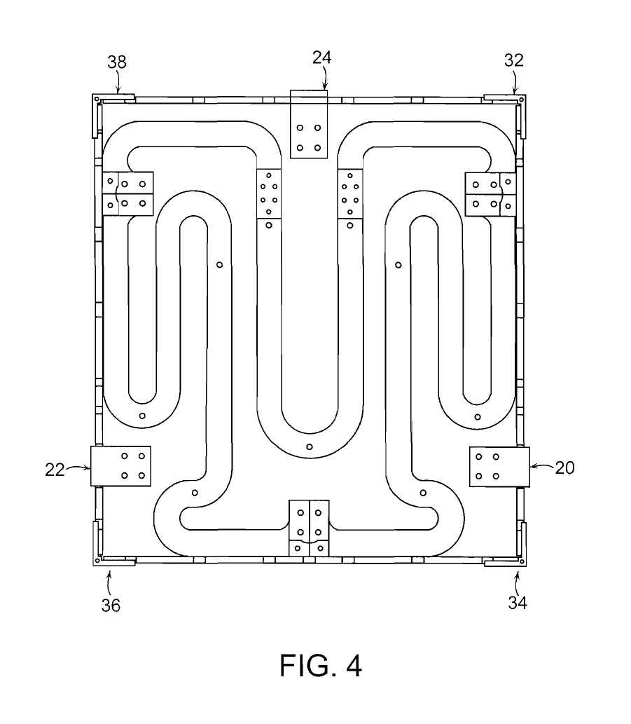

One or more additional connecting elements preferably are provided for interconnecting one or more sections of the first and second heating components 12 and 14, respectively. Referring to FIGS. 3 and 4, a plurality of connecting elements or clips 32, 34, 36, and 38 are provided for connecting multiple sections of the second heating component 14, where the clips 32, 34, 36, and 38 are provided at corners linking different sections of the second heating component 14 or side heater. Similar connecting elements or clips can be provided to interconnect sections of the first heating component.

For clarity, the heating clips 20, 22, and 24 are shown unconnected with the crystal growth apparatus 2 and the first heating component 12 in FIGS. 2-4. However, in practice, each of the clips is configured to connect at least one of the first heating component 12 and the second heating component 14 with the crystal growth apparatus 2, through interconnections between the electrode 6, support element 4, and the apparatus 2. Each of the clips further is configured to interconnect the first and second heating components 12, 14. For example, as shown in FIG. 3, an underside of each clip is configured to be connected with a section of the first heating component 12, such that the first and second heating components 12, 14 are mechanically linked together, and preferably thermally and electrically connected, during use.

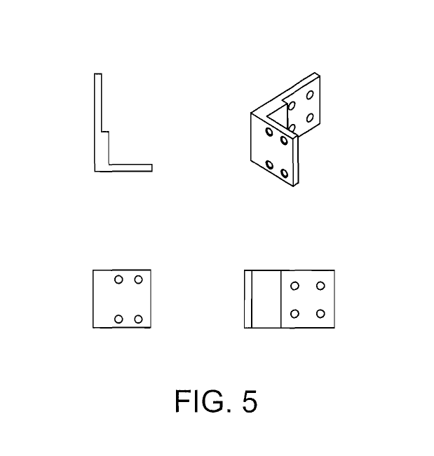

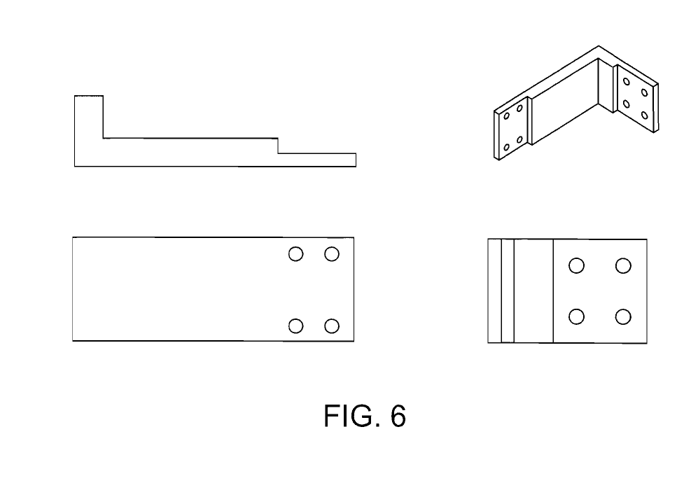

FIGS. 5 and 6 depict alternate preferred embodiments of heater clips useful in the subject invention. A suitable heater clip can be selected based, for example, on the desired distance at which the heating element is to be arranged with respect to the crucible in the crystal growth apparatus. For example, for a given size of crystal growth apparatus, a longer heater clip, such as shown in FIG. 6, would provide a closer proximity of the heating element with respect to the crucible containing the growth material, for example, a silicon charge. By comparison, a shorter heater clip, such as shown in FIG. 5, would provide a longer distance between the heating element and the crucible. In other words, a particular heater clip configuration can be selected based on a predetermined distance between the heating element, or one or more heating components of the heating element, and the crucible. As provided herein, different sizes and configurations of heater clips can be used to control heat flow during directional solidification.

It is also possible to select a particular heater clip based on the number of heating components utilized. For example, if only the second heating component (side heater) is used, a shorter heater clip may be utilized, in which case the heater clip of FIG. 5 would be preferred.

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications and other references cited herein are hereby expressly incorporated herein in their entireties by reference.

What is claimed is:

1. A crystal growth apparatus, comprising:
a feedstock material received in a crucible, the crucible arranged in the apparatus; and
a heating element arranged in the apparatus, the heating element including at least a first heating component operably connected to a second heating component, the first and second heating components configured to heat and melt the feedstock material.

2. The crystal growth apparatus of claim 1, wherein the first and second heating components are connected via the same circuit.

3. The crystal growth apparatus of claim 1, wherein the first and second heating components are electrically coupled to each other.

4. The crystal growth apparatus of claim 1, wherein the first and second heating components are thermally coupled to each other.

5. The crystal growth apparatus of claim 1, further comprising at least one clip configured to connect at least one of the first heating component and the second heating component to the apparatus.

6. The crystal growth apparatus of claim 5, wherein the at least one clip is configured to interconnect the first and second heating components.

7. The crystal growth apparatus of claim 5, wherein the at least one clip is sized such that at least one of the first and second heating components is arranged at a predetermined distance from the crucible.

8. The crystal growth apparatus of claim 1, further comprising a plurality of clips arranged on the heating element for connecting the heating element to the apparatus.

9. The crystal growth apparatus of claim 8, further comprising a plurality of fasteners for being received in the clips.

10. The crystal growth apparatus of claim 1, wherein the first and second heating components are arranged along the top and sides, respectively, of the crucible.

11. A crystal growth apparatus, comprising:
a feedstock material received in a crucible, the crucible arranged in the apparatus; and
a heating element arranged in the apparatus, the heating element including at least a first heating component connected to a second heating component by at least one clip, the first and second heating components configured to heat and melt the feedstock material.

12. The crystal growth apparatus of claim 11, wherein the at least one clip is sized such that the heating element is arranged at a predetermined distance from the crucible.

13. The crystal growth apparatus of claim 11, wherein the at least one clip is configured to connect the heating element to the apparatus.

14. The crystal growth apparatus of claim 11, wherein the first and second heating components are connected via the same circuit.

15. A method for arranging a heating element in a crystal growth apparatus, comprising the steps of:
receiving a feedstock material in a crucible, the crucible arranged in the apparatus; and
positioning a heating element relative to the crucible, the heating element including at least a first heating component operably connected to a second heating component, the first and second heating components configured to heat and melt the feedstock material.
